(19) United States
(12) Patent Application Publication
(10) Pub. No.: US 2004/0135033 A1
(43) Pub. Date: Jul. 15, 2004

(54) Parachute

(76) Inventor: Fa-Sheng Hung, Taipei Hsien (TW)

Correspondence Address: SHOEMAKER AND MATTARE, LTD, 10 POST OFFICE ROAD - SUITE 110, SILVER SPRING, MD, 20910, US

(21) Appl. No.: 10/340,850

(22) Filed: Jan. 13, 2003

(51) Int. Cl. B64D 17/00; B64D 21/00; B64D 19/00

(52) U.S. Cl. 244/142

(57) ABSTRACT

A parachute structure is introduced, including a supporting tube that contains a second inner tube having a first inner tube contained in its hollow tube body, wherein the supporting tube further includes a pushing bar to push up the first inner tube; and a plurality of parachute canopy folded and superposed on the supporting tube, such that the canopy is held and lifted up with the semi-circular holding part above the first and second inner tubes in a half-extended state. Each canopy of the parachute is pushed up by adjusting positions to lift up the first and second inner tubes of the supporting tube, for allowing the user to easily maneuver the extension of the canopy, making it an efficient escape tool that is not only very mobile and easy to maneuver, but is also bandy in terms of packing up for storage.

### FIELD OF THE INVENTION

The present invention relates to a parachute, and more particularly, to a parachute having a plurality of canopy superposed on a supporting tube, easy to operate and compact in size, so as to allow individual facing the emergency situation to escape from a high building to the ground.

### BACKGROUND OF THE INVENTION

An advanced facility that can effectively save more human lives and reduce casualties during incidents of massive fares is provided in view of the 911 terrorists' attack that took place and crashed Twin Tower building in New York City. In this tragedy, victims were unable to escape in time due to lack of effective equipment at hand provided before the building collapsed As a result, those people that were trapped at the higher areas of the building have sacrificed their lives along with the collapse of the buildings.

The most efficient way of evacuating the residents in the skyscraper when experiencing terrible plane crash attack or serious fire is to use a parachute as a tool to escape. As the relevant information was studied, the conventional parachute usually has a canopy of 6 meters in diameter. Due to the huge size of the canopy, a larger landing area is required when such parachute is used, so as to extend the canopy by enough resistance produced by the air current turbulence. Therefore, this makes the conventional parachute not suitable as a tool for escaping from the high buildings. Also, it is very complicated to pack up the conventional parachute, which is not easily maneuvered by a novice, contributing another reason not to choose the conventional parachute as the tool for escaping from the high buildings.

In light of the fact that the conventional parachute was not suitably used as a tool for escaping from a high area, a huge amount of investigation work has been put to research and modify from the available parachute. So, with many years of experience and continuous tests, the parachute of the present invention is developed.

### SUMMARY OF THE INVENTION

An objective of the present invention is to provide a parachute that is easy to operate, so as to enable individual facing the emergency accident to escape safely and efficiently from a high building to the ground.

Another objective of the present invention is to provide a parachute having its canopy to be folded up easily, so as to make the parachute compact in size and mobile to different places.

In accordance with the objective, the present invention proposes the parachute having a plurality of canopy superposed on a supporting tube, wherein the supporting tube contains a first inner tube, and the first inner tube further contains a second inner tube. And on the first inner tube and the second inner tube, round shielding bodies are formed to touch on the corresponding canopies, such that the canopies are held up to result a half extended state when the first and second inner tubes are operated to rise up along the supporting tube. And a plurality of first supporting frames are formed at the periphery of the canopy, wherein each of the first supporting frame has one end coupled to the supporting tube and another end coupled to the second supporting frame so as to support peripheral part of a plurality of the canopy as the canopy is extended. And each layer of the canopy is fastened by a fastening rope whose other end is fixed at the ball-shaped shielding body on the upper part of the supporting tube. So as the parachute user adjusts the position for the first and second inner tubes to rise up the first and second supporting frames are pulled to extend by the canopy, resulting a pre-extended state at the peripheral region of the canopy. As a result, the user can quickly engage into the fully extended operation during landing. This greatly reduces height required for the canopy to fully extend. Therefore, with the parachute of the present invention, anyone who experience major disaster at the higher area may be able to escape to the ground.

### BRIEF DESCRIPTION OF THE DRAWINGS

The present invention can be more fully understood by reading the following detailed description of the preferred embodiments, with reference made to the accompanying drawings, wherein:

FIG. 1 is a schematic diagram illustrating a parachute canopy in an extended state according to the present invention;

FIG. 2 is a schematic diagram illustrating an internal structure of the supporting tube and the first looping ring according to the present invention;

FIG. 3 is a schematic diagram illustrating structure of the first inner tube containing the top bar;

FIG. 4 is a schematic diagram illustrating the supporting tube in operation according to the present invention; and

FIG. 5 is a schematic diagram illustrating the parachute canopy in a folded state according to the present invention.

### DETAILED DESCRIPTION OF THE PREFERRED EMBODIMENTS

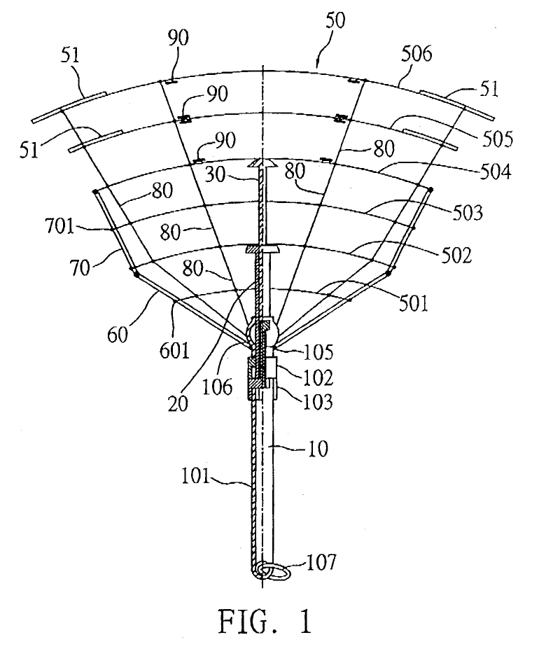

As shown in FIG. 1, the parachute comprises: a supporting tube 10 having a vertical guide groove 101 formed centrally therein, wherein the supporting tube 10 has a hollow portion for containing a second inner tube, and the second inner tube 20 has a hollow portion for containing a first inner tube 30; a plurality of canopy 50 folded and superposed in sequence on the supporting tube 10, a plurality of first supporting frames 60, arranged symmetrically as a ring in the periphery of the canopy to couple to a plurality of second supporting frames 70, such that the inner layer of the canopy 50 is supported to complete the extension; and a plurality of fastening ropes evenly distributed to each canopy 50 to provide a clustered connection, so that a buffering force produced by each canopy 50 during landing can act on the supporting tube 10.

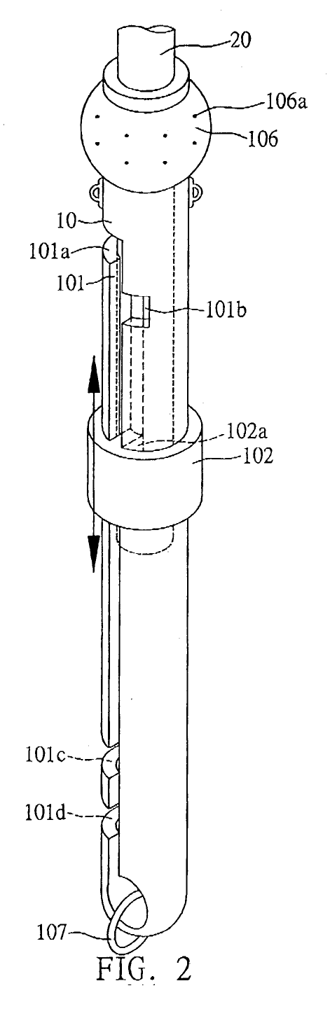

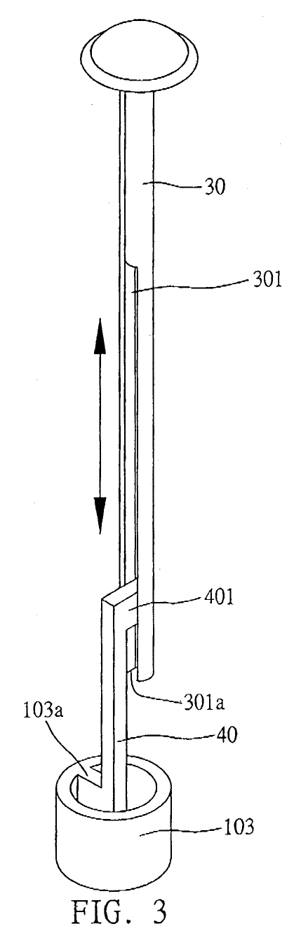

On an edge of the supporting tube 10, a vertical guide groove 101 is formed, allowing a first looping ring 102 and a second looping ring 103 that embrace the supporting tube 10 to slide up and down along the guide groove 101, wherein an outwardly projected connecting rib 102a is formed along portions of the inner circumferential wall of the first looping ring 102 corresponding to the guide groove 101. Referring to both FIGS. 1 and 2, the connecting rib 102a has the other end extending into the guide groove 101 and fixing to the wall of the second inner tube 20 contained in the supporting tube 10. Similarly, an outwardly projected connecting rib 103a is formed along portions of the inner circumferential wall of the second looping ring 103 corresponding to the guide groove 101. The connecting rib 103a has the other end extending into the guide groove 101 and fixing to an arm of a pushing bar 40 contained in the second inner tube 20. Referring to both FIGS. 1 and 3, a pushing portion of the pushing bar 40 forms a sideway-projected holding part 401. And a vertical guide groove 301 is formed by extending upwards from a bottom opening part 301a of the first inner tube 30 contained in the second inner tube 20, so that the holding part 401 of the pushing bar 40 can insert along the guide groove 301, allowing the first inner tube to slide downwards into the second inner tube 20.

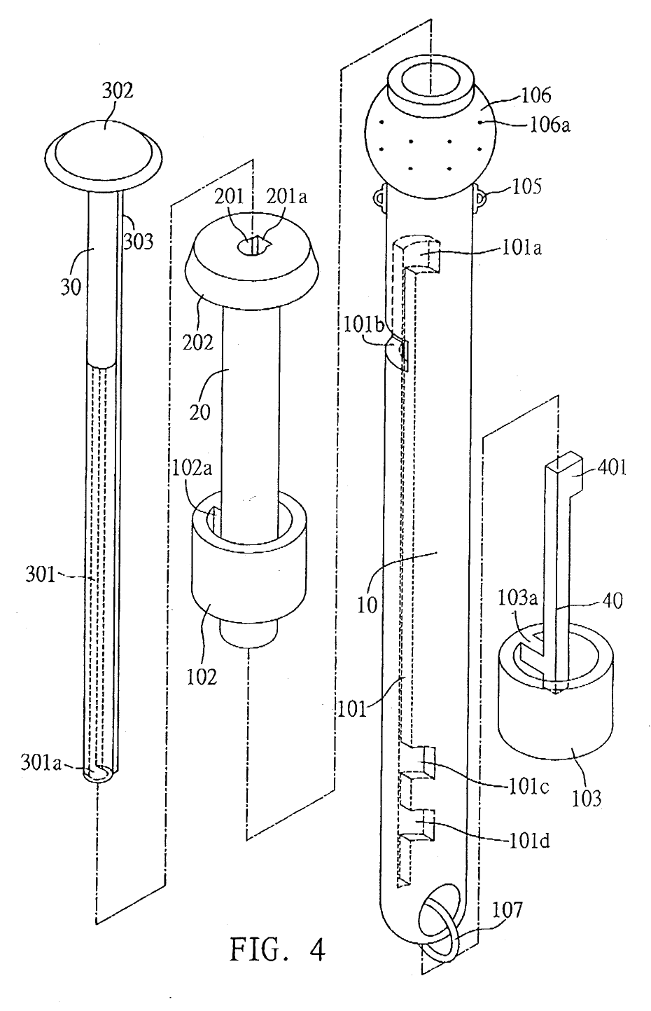

As illustrated in FIG. 4, several side grooves 101a, 101b, 101c, and 101d are formed along longitudinally along the guide groove 101 of the supporting tube 10, such that the connecting rib 102a can lock with the side grooves 101a and 101c when the first looping ring is rotated alone the supporting tube 10. With a rise of the first looping ring 102 along the guide groove 101 of the supporting tube 10, the second inner tube 20 that is coupled to the connecting rib 102a is lifted up together. As a result, the first inner tube 30 contained in the second inner tube 20 is lifted to the same height as that of the second inner tube 20 which is lifted by the first looping ring 102.

And when the second looping ring is rotated along the supporting tube, the connecting rib 103a locks with the side grooves 101b and 101d, wherein the side groove 101b is recessed from one side of the guide groove 101, but other side grooves 101a, 101c and 101d are formed on the other side of the guide groove 101. So, when the second looping ring 103a rises along the guide groove 101 of the supporting tube, the pushing bar 40 that is coupled to the connecting rib 103a is lifted up together.

When the first looping ring 102 is pushed up from the side groove 101c of the supporting tube 10 to lock in the side groove 101a. the second inner tube 20 in the supporting tube 10 and the first inner tube 30 contained in the second inner tube 20 are lifted together to the same height. Then, the second looping ring 103 is rotated to free the connecting rib 103a from the side groove 101d, while the pushing bar that is coupled to the connecting rib 103a is also rotated, such that the holding part above the pushing bar 40 is held at the bottom edge of the first inner tube 30 that has been lifted up. Next, the second looping ring 103 is pushed from the side groove 101d to lock in the side groove 101b, so that the first inner tube 30 is held by the pushing bar 40 and lifted with the second looping ring 103 to the same height.

For the first inner tube 30 described above, a projecting edge 303 is formed on one side of its outer tube wall, whereas a groove 201a is formed on the corresponding edge of the guide hole 201 in the second inner tube 20 that encases the first inner tube 30, such that the first inner tube 30 is prevented from rotating in the second inner tube 20 when the projecting edge 303 is locked in the groove 201a. And respectively, the pushing parts of the first inner tube 30 and second inner tube 20 form arc-shaped holding bodies 302 and 202 which touch on the canopy 50 folded in sequence when the first inner tube 30 and second inner tube 20 are packed up. But, when the first looping ring 102 and the second looping ring 103 are rotated to rise up along the supporting tube 10, the holding bodies 302 and 202 can hold up the canopies 504 and 502 in an extended state as illustrated in FIG. 1.

Referring to FIG. 1, a plurality of fastening bases 105 are formed symmetrically on the pushing part of the supporting tube 10, for fastening to a plurality of first supporting frames 60 fixed on a periphery of the canopy. The other ends of the plurality of first supporting frames 60 are then fastened to second supporting frames 70 that can be flipped and folded upwards, wherein through holes 601 and 701 of the first supporting frames 60 and second supporting frames 70 are formed on the edges that connect to the canopies 501, 502, 503, and 504, such that the canopies 501, 502, 503, and 504 are fixed via the through, holes 601 and 701 to the first supporting tube 60 and the second supporting tube 70, so as to generate a partial haulage-extended action for the canopy 50. And supporting tubes 51 are formed on a periphery of the canopies 505 and 506, such that sidewise forces are generated towards outside for the periphery of the canopy 50, allowing the canopy to fully extend more conveniently during landing.

A ball-shaped shielding body 106 is formed on the pushing end of the supporting tube 10, wherein a plurality of through holes 106a are formed on parts of the ball-shaped shielding body that correspond to fastening ropes 80 transversely bound to canopy 50. Each of the through holes 106a allow one end of each fastening ropes 80 to penetrate and be fixed within the shielding body 106, so that each fastening rope 80 can transmit a buffering force generated after the canopy 50 is maneuvered against air current resistance to act on the supporting tube 10. And a fastening hoop 107 to buckle on a circumferential belt worn by an escaper. As a result, with the buffering force generated with the canopy, the escaper can land to the ground slowly from a high area, so as to achieve a safe use during an emergency escape.

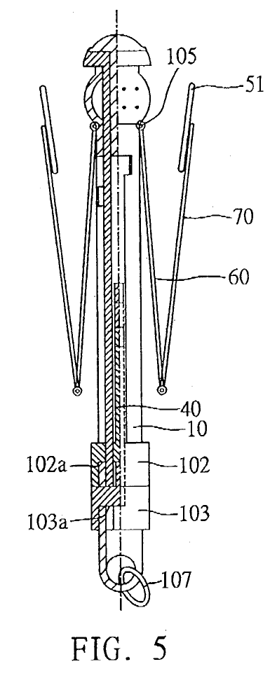

Referring to both FIGS. 4 and 5, when the parachute needs to be packed up from the previous extended state, the first looping ring 102 and the second looping ring 13 are rotated to be released from locking positions of the side grooves 101a and 101b. After that, the second looping ring 103 and the first looping ring 102 are slid down to lock in the side grooves 101d and 101c, such that the pushing part 401 of the pushing bar 40 that is coupled to the connecting rib 103a matches the opening 301a at the bottom of the first inner tube 30 when the connecting rib 103a of the second looping ring 103 is locked in the side groove 101d. As a result, the pushing bar 40 does not push against the bottom edge of the first inner tube 30, and the pushing part 401 of the pushing bar 40 is inserted in the guide groove 301 of the first inner tube 30, so that the first inner tube 30 may be slid down and retracted to the second inert tube 20, where the first inner tube 30 is contained. And when the first looping ring 102 is rotated and slid down to lock in the side groove 103c, the connecting rib 102a that is fixed to the second inner tube 20 is slid down together with the second inner tube 20 and the first inner tube 30, all of which are then retracted to the supporting tube 10.

While the first inner tube 30 and the second inner tube 20 are withdrawn to the supporting tube 10, each of the held-up canopy 50 drops down to fold together (the canopy is not shown in FIG. 5 for illustrating a better view). And adhesive tapes 90 are formed on the canopies 506 and 505 that are not pushed up by the first inner tube 30 and the second inner tube 20 as well as the canopy 504 that is pushed up by the first inner tube 30, so as to enable adhesion of the canopies 504, 505, and 506 in order to prevent sideway tilting.

After the canopy 50 drops down and folds together, the first supporting frame 60 and the second supporting file 70 that are coupled to the periphery of the canopy 50 lose a pulling force of the fastening rope 80. This causes bending of the supporting frames 60 and 70, both of which are then packed up as a bundle to the side of the supporting tube 10. This greatly reduces volume of the whole parachute, making the parachute easier to store and more portable with wider application elsewhere.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A parachute, comprising:
a supporting tube having a vertical guide grove formed therein, wherein the supporting tube has a hollow portion for containing a second inner tube, and the second inner tube has a hollow portion for containing a first inner tube; a plurality of canopy folded and superposed in sequence on the supporting tube; a plurality of first supporting frames, arranged symmetrically as a ring in the periphery of the canopy to couple to a plurality of second supporting frames, such that an inner layer of the canopy is supported to complete the extension; and a plurality of fastening ropes evenly distributed to each canopy 50 to provide a clustered connection
wherein the above mentioned guide groove in the supporting tube allows a first looping ring and a second looping ring to slide along the supporting tube, such that a first outwardly projected connecting rib is formed along portions of the inner circumferential wall of the first looping ring to extend into the guide groove and fix to the wall of the second inner tube, and a second outwardly projected connecting rib is formed along portions of the inner circumferential wall of the second looping ring to extend into the guide groove and fix to an arm of a pushing bar contained in the second inner tube.

2. The parachute of claim 1, wherein a sideway-projected holding part is formed on a top bar contained in the supporting tube, for matching an opening part at bottom of the first inner tube contained in the second inner tube, and a guide groove is formed by recessing upwards along the opening part at bottom of the first inner tube.

3. The parachute of claim 1, wherein the pushing end of the supporting tube has a ball-shaped shielding body formed thereon, with a plurality of through holes formed on parts of the ball-shaped shielding body that correspond to fastening ropes transversely bound to canopy.

4. The parachute of claim 1, wherein arc-shaped holding bodies are formed on the first inner tube and second inner tube such that the canopies are held in an extended state when the first inner tube and the second inner tube rise up from the supporting tube.

5. The parachute of claim 1, wherein a plurality of fasted bases are formed symmetrically on the supporting tube, for fasting to a plurality of first supporting frames fixed on a periphery of the canopy, with other ends of the plurality of first supporting frames fastening to second supporting frames to be flipped and folded upwards.

6. The parachute of claim 1, wherein a projecting edge is formed on one side of outer tube wall of the fire inner tube, and a groove is formed on the corresponding edge of the guide hole in the second inner tube.
